(19) United States
(12) Patent Application Publication
(10) Pub. No.: US 2011/0179765 A1
(43) Pub. Date: Jul. 28, 2011

(54) Jet engine shield and deicer

(76) Inventor: Anthony S. Lalli, Santa Fe, NM (US)

(21) Appl. No.: 12/806,385

(22) Filed: Aug. 12, 2010

Related U.S. Application Data
(60) Provisional application No. 61/336,427, filed on Jan. 22, 2010.

(51) Int. Cl. F02G 3/00

(52) U.S. Cl. 60/39.093

(57) ABSTRACT

A shield or protective grille assembly constructed of non-corrosive and heat conductive metal members (10, 12 & 14), conforming to the configurations shown on the drawings, said assembly design inducing airflow and having the structural integrity required for the purpose of screening and/or deflecting birds and/or other airborne objects, said shield performing a deicing function by means of a heating capability incorporated within the members of the shield assembly.

### CROSS-REFERENCE TO RELATED APPLICATIONS

| U.S. Pat. No. | Title | Issue Date |
|---|---|---|
| 2,663,993 | Deicing Apparatus | Dec. 29, 1953 |
| 4,149,689 | Protective Screen For Jet Engine Intake | Apr. 17, 1979 |
| 4,783,026 | Anti-Icing Management System | Nov. 8, 1988 |
| 5,365,731 | Efficient Anti-Ice Exhaust Method | Nov. 22, 1994 |
| 5,411,224 | Guard For Jet Engine | May 2, 1995 |
| 7,131,612 | Nacelle Inlet Lip Anti-Icing With | Nov. 7, 2006 |
| | Engine Oil | |

### BACKGROUND

1. Field of the Invention

This innovation relates to assemblies attached to the air intake openings of aircraft jet engines for the purpose of screening and/or deflecting birds and other airborne objects, said assemblies incorporating anti-icing capabilities.

2. Description of Prior Art

Birds, ice particles, hail and other airborne objects have at times been drawn into the air intake openings of aircraft jet engines, causing engine malfunction and/or failure. This author is aware of protective screens and filters presently used for various machines and engines which allow for the intake of air while screening damaging material, but is not aware of air intake shields or screens currently being used for aircraft jet engines, although numerous patents have been submitted.

Some patent submittals have proposed various types of protective screen or shield assemblies which, when reviewed, would seem to restrict the intake of air for proper engine function due to the density of screening components or by the inadequate provision for the prevention of ice formation on said assemblies. Other patent submittals have suggested the prevention of ice formation by the supplying of exhaust gases from the engine exhaust or the removal of ice by vibration. These and other screening proposals typically provide externally applied methods of deicing and would seem less adequate than the internal deicing function of the innovation presented herein.

### SUMMARY

This innovation is comprised of an assembly installed at the cowling lip of the air intake opening of a jet engine, said assembly designed for the purpose of preventing the entry of birds and other airborne objects and incorporating an anti-icing function, this proposed design allowing for the unobstructed intake of air required for normal engine operation.

### ADDITIONAL OBJECTS AND ADVANTAGES

Accordingly, besides the general objects and advantages of the air intake shield described above, some of the specific advantages of this innovation are:

(a) a shield assembly having a removable attachment to the engine cowling lip for the purpose of providing the clear access required for performing engine maintenance;

(b) a shield assembly incorporating a heating/deicing capability energized by the aircraft electrical system;

(c) an electrical system having the capability to sensor incoming temperature value and proportionately activating heating elements within the shield assembly.

### DRAWING FIGURES

FIG. 1 shows the exterior top, sides and bottom views of the jet engine cowling with attached air intake shield.

FIG. 2 shows the front view of the jet engine cowling with attached air intake shield.

FIG. 3 illustrates a section between the engine cowling and air intake shield, viewing said cowling and indicating the connector ring on the near side.

FIG. 4 illustrates a section between the engine cowling and air intake shield, viewing interior of said shield and indicating cowling on the near side.

FIG. 5 illustrates a section through the cowling and connector ring, indicating electrical contacts at cowling lip and connector ring, cowling shown outlined for clarity.

FIG. 6 illustrates a section through a typical tubular rod with heating element and heat conductive material within said rod.

FIG. 7 illustrates a front view of an alternative air intake shield consisting of fewer tubular rods comprising the shield assembly.

### REFERENCE NUMERALS IN DRAWINGS

| | |
|---|---|
| 10 metal cap | 12 connector ring |
| 14 tubular rod | 16 outer cowling surface |
| 18 electrical contact at connector ring | 20 electrical contact at cowling lip |
| 22 inner cowling surface | 24 electrical system |
| 26 heating element | 28 heat conductance material |

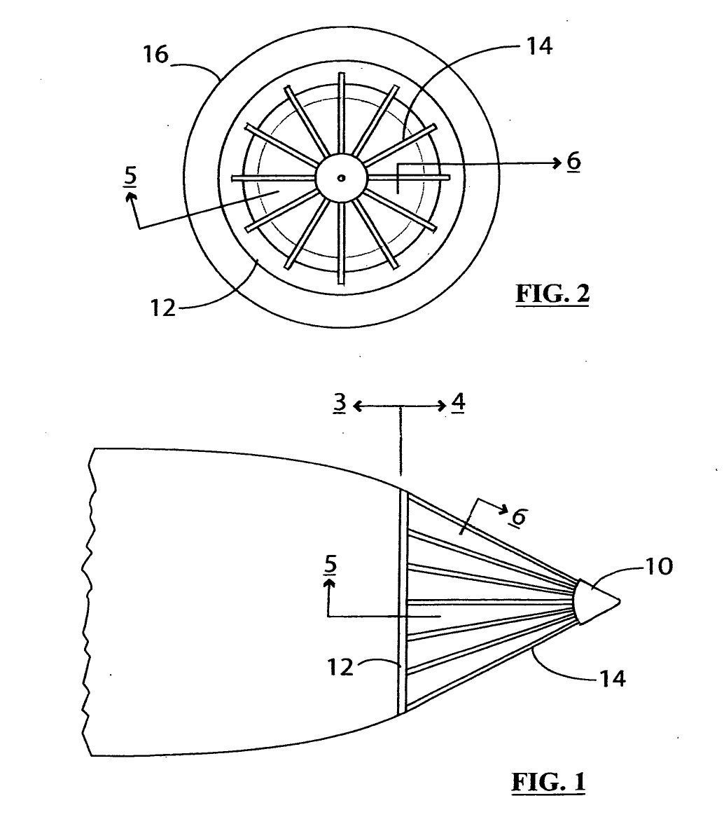

### FIG. 1 through FIG. 6

### Preferred Embodiment

The preferred embodiment of this proposed air intake shield is illustrated in FIG. 1 through FIG. 6 as shown on drawings, the illustrated assembly constructed of similar diameter, tubular metal rods enclosing heating elements, said rods welded to or otherwise attached to a connector ring, said assembly having a removable attachment to the cowling lip.

The rods comprising the shield form a cone shaped assembly converging forward from the connector ring with each rod uniformly placed at an angle of 30 degrees relative to the cowling axis, the forward end of the assembly being shaped and welded or otherwise joined together as required to form a pointed tip covered by a metal cap, the apex of said cap in alignment with the cowling axis.

Parts making up the shield assembly shall be fabricated from non-corrosive and heat conductive metal, said assembly having the structural stability required to withstand the impact of birds and/or other flying objects.

### Additional Embodiment

An additional embodiment regarding electrification of the shield assembly would be by direct contact with an electrical storage unit or battery, said unit being energized by the aircraft electrical system.

### Alternative Embodiments 1. An alternative to the rod assembly shown in FIG. 2 and described in the preferred embodiment above is illustrated in FIG. 7 which shows a lesser number of rods and fewer electrical contacts at the cowling lip and connector ring, with all other specified requirements and details shown in the drawings being applicable.

2. An alternative embodiment of the heating element and conductive material within the typical tubular rod shown in FIG. 6 would be the replacement of the shown heating element with a larger diameter element, completely filling the tube interior so as not to require additional heat conductive material.

3. An alternate to the shield assembly indicated in the preferred embodiment would consist of a forward pointing and uniform placement of assembly rods at an inclination other than the preferred embodiment described herein.

4. In lieu of individual electrical contacts at both the lip of the engine cowling and the connector ring, another arrangement option would be the use of a continuous electrical contact strip at the cowling lip while still employing the use of individual electrical contacts at the connector ring interface with the cowling lip, the individual contacts placed in alignment with the rods of the shield assembly as shown in FIG. 4.

5. An alternate possibility regarding the circular tubular members comprising the shield assembly as shown in FIG. 6, would be the employment of oval, square, rectangular or other multi-sided members in sectional configuration, hollowed so as to enclose heating elements as described herein.

### Additional Embodiment Advantage

The advantage of the additional embodiment, incorporating an electrical storage unit as described herein would be the continuous deicing function of the air intake shield in the event of stoppage or malfunction of the aircraft electrical system.

### Alternative Embodiment Advantages

The advantage of the shield assembly described in item 1 would be the providing of less obstructive air intake as compared to the assembly illustrated in FIG. 2. This alternative assembly as illustrated in FIG. 7, however, does not have the screening capability of the preferred embodiment so that a judgment, supported by aerodynamic testing, will be required to determine which embodiment offers a superior balance of air intake and screening capability.

The possible advantage of item 2, providing a larger diameter heating element so as to omit the need for additional heat conductive material, would be a matter of fabrication economy and/or expediency.

The advantage of item 3, in which assembly rods are positioned at a uniform angle other than the 30 degree angle relative to the cowling axis, if supported by aerodynamic testing, could result in an assembly offering a superior screening/deflection capability.

The possible advantage of item 4, specifying the employment of a continuous electrical contact strip in lieu of individual contacts at the cowling lip, would be the prevention of misalignment of individual contacts, considering the removal and reinstallation of the shield assembly for maintenance purposes, this alternative possibly providing fabrication economy and/or expediency.

The advantage of item 5, employing the use of shield members with a sectional shape other than circular, if determined by aerodynamic testing, could provide superior airflow over the assembly and increased deflection capability.

### Operation

### FIG. 1 Through FIG. 6

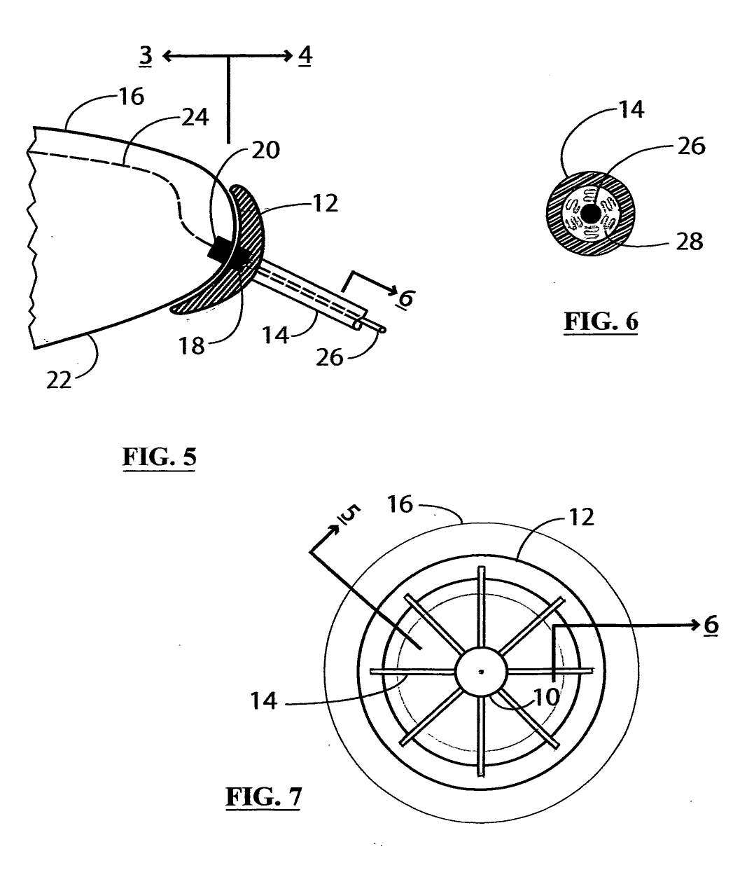

This jet engine shield and deicer consists of a cone shaped, forward pointing assembly comprised of tubular metal rods (14) shown in FIG. 1 & FIG. 2, welded to or otherwise attached to a connector ring (12) shown in FIG. 5, which is anchored to the engine cowling lip, said assembly being removable for maintenance purposes, all components fabricated from non-corrosive and heat conductive metal having the structural integrity required for screening or deflecting birds and other airborne objects.

This proposed air intake shield, because of it's forward pointing and conical design as shown in FIG. 1, would provide sufficient airflow over the shield assembly so as to screen or deflect airborne objects such as birds, ice particles and hail, thereby preventing the possibility of retaining these objects on said shield and providing the unobstructed air intake required for proper engine operation.

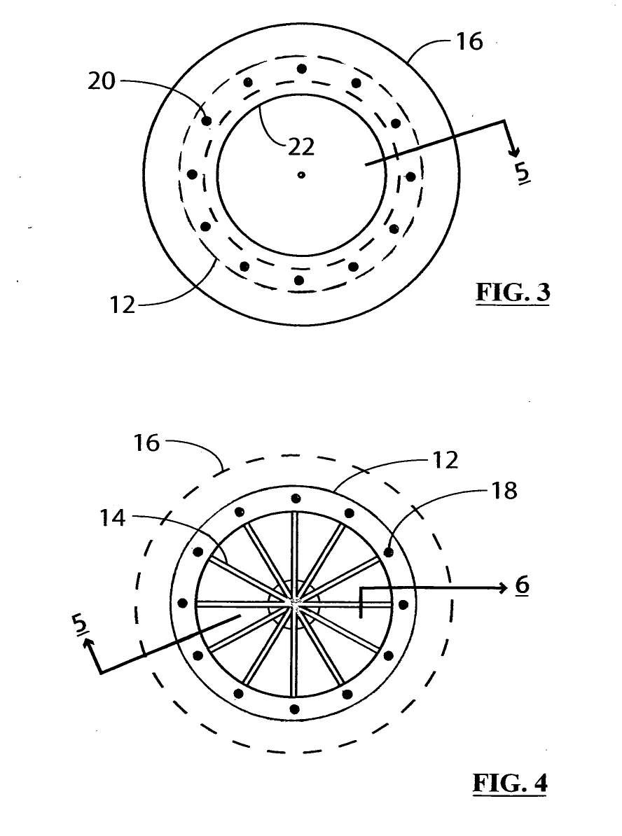

The deicing capability of this proposed shield is performed by heating elements (26) and heat conductive material (28) within the tubular rods as shown in FIG. 6, said heating elements piercing and terminating in electrical contacts (18) at the interface surface of connector ring (12) and cowling lip as shown in FIG. 4, said lip containing electrical contacts (20) as shown in FIG. 3, said contacts electrified by the aircraft electrical system and aligned with contacts at the connector ring.

The aircraft electrical system (16) as indicated in FIG. 5, which is the source for electrifying the contacts (20) on the surface of the cowling lip as shown in FIG. 3, incorporates a sensor in the path of incoming air which would determine when temperature falls to or below a predetermined value, thereby generating a signal that provides proportional heating capability to the heating elements within the tubular rods comprising the air intake shield assembly and preventing the formation of ice on said shield assembly.

### CONCLUSION, RAMIFICATIONS AND SCOPE

Accordingly, the reader will see that this proposed air intake shield with screening, deflection and deicing capability is intended to provide the optimal operation of jet airplane engines for the safety of crew and passengers as well as preservation of the aircraft.

Although the idea presented may contain some specifics, these should not be construed as limiting the scope of the idea presented, and is merely meant to illustrate the preferred embodiment thereof. For example, the connector ring described in this proposal would be shaped as required to conform to the cowling lips of various aircraft.

Regarding this proposal, those skilled in the process may envision that other possible variations are possible within its scope. Also, the shield or grille configuration shown is only one of many possible variations, and testing may provide design and construction that provides more effective performance.

Thus, the scope of this idea should be determined by the appended claims and their legal equivalents, rather than by the examples given.

1. A jet engine shield and deicer assembly, wherein this improvement comprises:
1. a removable attachment of said assembly to the air intake lip of a jet engine cowling, allowing clear access to the engine for repair and maintenance purposes.
2. a design configuration inducing sufficient airflow over said assembly, thereby providing a capability to screen and/or deflect airborne objects,
3. an integral heating/deicing capability energized by the aircraft electrical system,
4. said electrical system incorporating a sensing capability to determine the temperature value of incoming air and proportionately activating the heating elements within the shield assembly,
whereby the engine is protected from flameout or other malfunction due to the intake of birds, hail, and/or other airborne objects as well as protected from ice formation on the shield, thereby allowing the unobstructed intake of air required for normal engine operation.
